(19) United States
(12) Patent Application Publication
(10) Pub. No.: US 2007/0186734 A1
(43) Pub. Date: Aug. 16, 2007

(54) Hand tool with illumination display screen

(76) Inventor: Chih-Ching Hsieh, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/352,277

(22) Filed: Feb. 13, 2006

(51) Int. Cl. B25B 23/14

(52) U.S. Cl. 81/467

(57) ABSTRACT

A hand tool includes an elongate body and a function end is connected on a first end and a handle is located on the other end of the body. A control device is connected on an outside of the body and includes a display screen which includes an illumination member. The control device is electrically connected with strain gauges so as to display the values of torques that the tool outputs from the function end. The illumination member can be a back light board or light emitting diode such that the users read the information in the display screen in dark areas.

### FIELD OF THE INVENTION

The present invention relates to a hand tool having a control device on an outside of the tool and the display screen of the control device includes back light board or light emitting diode so that the user can read the information in dark.

### BACKGROUND OF THE INVENTION

A conventional hand tool generally used to tighten or loosen screws and includes many different functions to meet different requirements. In order to precisely control the torque that the hand tool applies to the object to be tighten, some hand tools include strain gauges which are deformed by the torque applied to the objects and the electric resistance is then detected by a control device of the hand tool so that the value of the torque can be calculated and displayed. By the information that the users protect the object from being overly twisted and broken. U.S. Pat. No. 6,119,562 discloses a hand tool that includes a display screen to show the value of the torque that the hand tool outputs. The torque is stopped output when the pre-set value is reached. However, when the hand tool is used in a dark area, the information displayed in the display screen cannot be read conveniently.

The present invention intends to provide a illumination display screen on a hand tool and which includes back light board or light emitting diode so as to provide light for night vision.

### SUMMARY OF THE INVENTION

The present invention relates to a hand tool that comprises an elongate body with a function end on a first end of the body and a handle is located on the other end of the body. A control device is connected on an outside of the body and includes a display screen which includes an illumination member so that the users can read the value in the display screen by using the illumination member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the control device on the elongate body of the hand tool of the present invention;

FIG. 2 is a plane view to show the control device on the elongate body of the hand tool of the present invention;

FIG. 3 is a perspective view to show the hand tool of the present invention, and

FIG. 4 shows that the display screen of the control device is an interactive screen and accepts commands by using an input pen.

### DETAILED DESCRIPTION OF THE PREFERRED EMBODIMENT

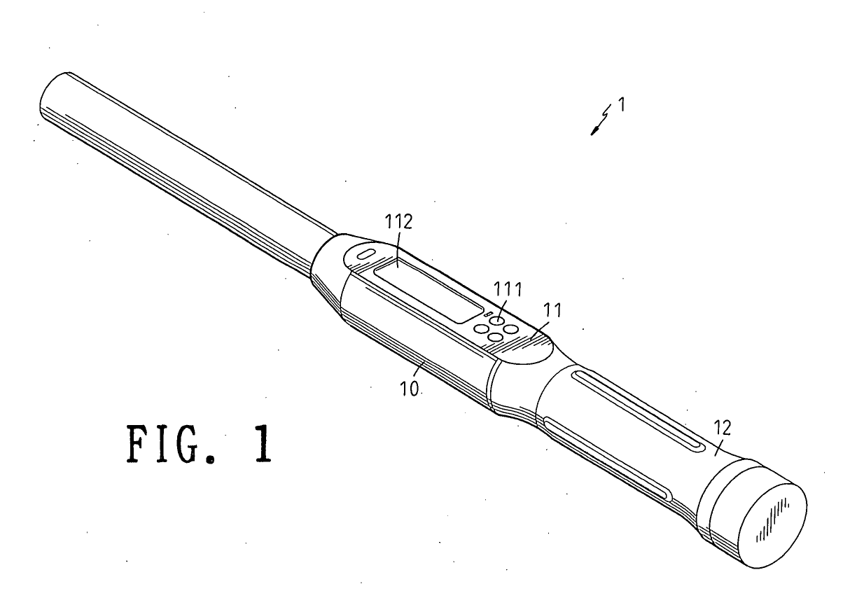

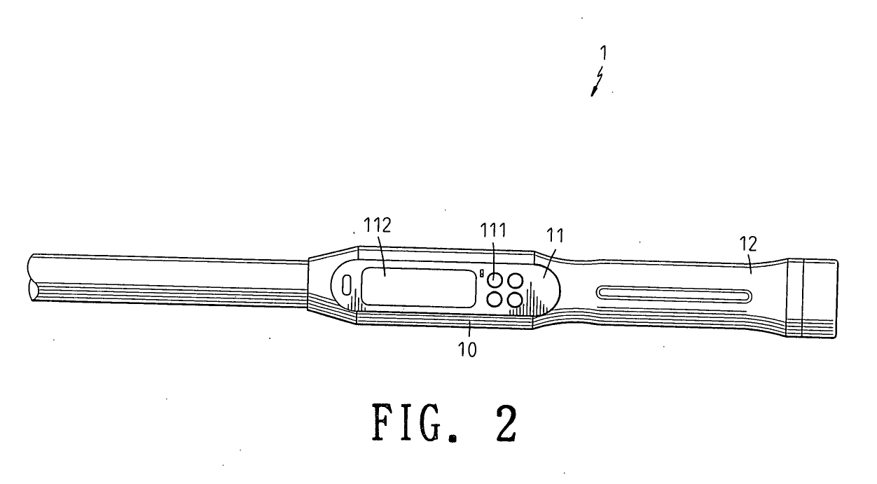

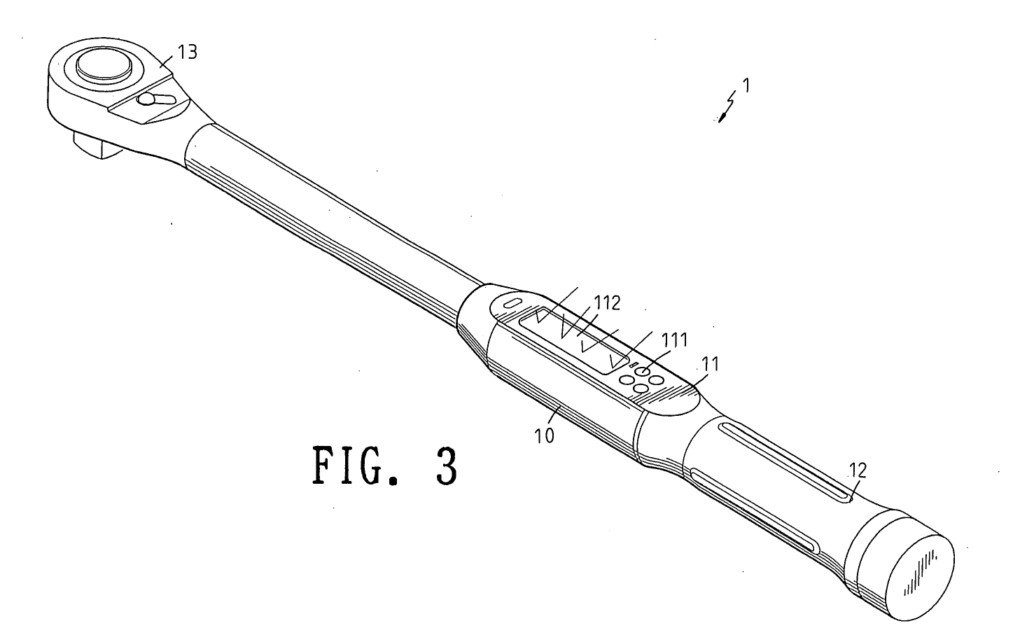

Referring to FIGS. 1 to 3, the hand tool 1 of the present invention comprises an elongate body 10 which has a function end 13 such as a ratchet socket driver on a first end thereof and a handle 12 is located on the other end of the body 10. A control device 11 is connected on an outside of the body 10 and includes a plurality of operation buttons 111 and a display screen 112 which includes an illumination member which can be a back light board and/or a light emitting diode. The hand tool 1 includes strain gauges connected to proper positions and the control device is electrically connected with the strain gauges so that when the hand tool 1 outputs torques, the strain gauges are deformed and the control device detects the changes of the electric resistance, and the changes are transferred via a CPU in the control device and the value of the torque is displayed in the display screen 112.

By the back light board and/or the light emitting diode, the value in the display screen 112 can be read in dark areas.

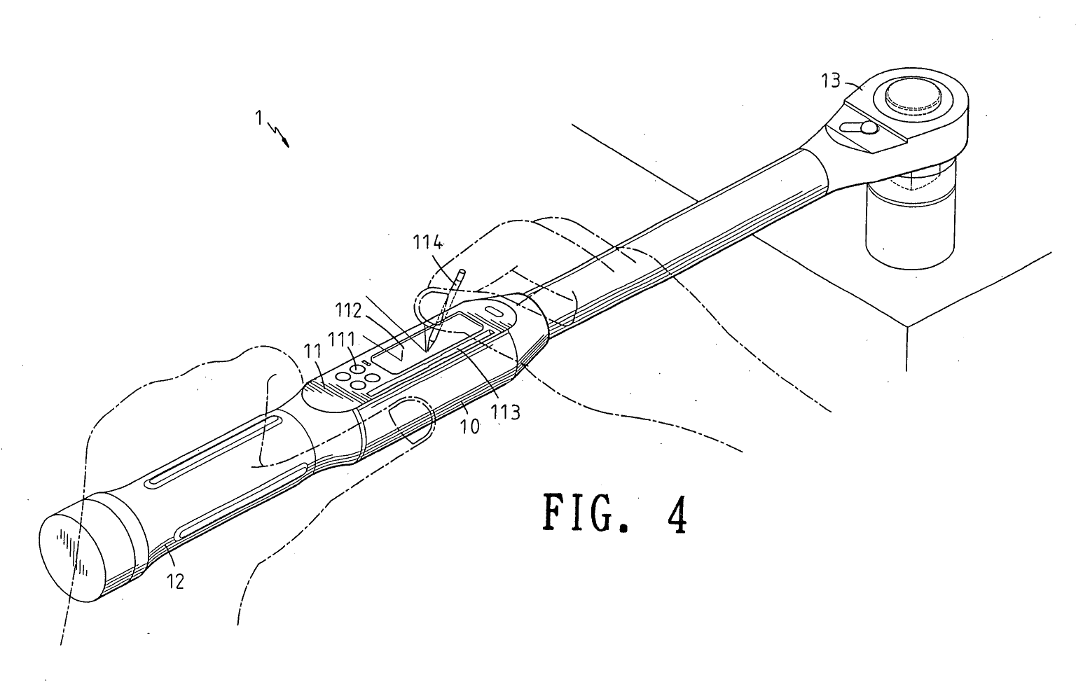

As shown in FIG. 4, the display screen 112 of the control device is an interactive screen and accepts commands by using an input pen 114 by the users. The input pen 114 can be received in a groove 113 defined beside the display screen 112.

While we have shown and described the embodiment in accordance with the present invention, it should be clear to those skilled in the art that further embodiments may be made without departing from the scope of the present invention.

What is claimed is:

1. A hand tool comprising:
an elongate body having a function end on a first end thereof and a handle located on the other end of the body, a control device connected on an outside of the body and including a display screen which includes an illumination member.

2. The tool as claimed in claim 1, wherein the function end is a ratchet socket driver.

3. The tool as claimed in claim 1, wherein the illumination member is a back light board.

4. The tool as claimed in claim 1, wherein the illumination member is a light emitting diode.

5. The tool as claimed in claim 1 further comprising a groove defined beside the display screen and an input pen removably engaged with the groove.
